(19) United States
(12) Patent Application Publication
(10) Pub. No.: US 2019/0317755 A1
(43) Pub. Date: Oct. 17, 2019

(54) METHOD FOR UPGRADING SOFTWARE OF POS TERMINAL, POS TERMINAL, AND STORAGE MEDIUM

(71) Applicant: PAX COMPUTER TECHNOLOGY (SHENZHEN) CO., LTD., Shenzhen (CN)

(72) Inventors: Heyu NIE, Shenzhen (CN); Jianqiang LI, Shenzhen (CN); Shifang DONG, Shenzhen (CN); Fuqiang DENG, Shenzhen (CN)

(73) Assignee: PAX COMPUTER TECHNOLOGY (SHENZHEN) CO., LTD., Shenzhen (CN)

(21) Appl. No.: 16/462,310

(22) PCT Filed: Aug. 30, 2017
(86) PCT No.: PCT/CN2017/099739

§ 371 Date: May 20, 2019

(30) Foreign Application Priority Data
Mar. 3, 2017 (CN) 201710125147.7

(51) Int. Cl. G06F 8/654; G06F 9/445; G07G 1/00

(52) U.S. Cl. CPC G06F 8/654; G07G 1/0009; G06F 9/44573

(57) ABSTRACT

A method for upgrading POS terminal software, including: starting a POS terminal; detecting whether the POS terminal is connected to a mobile storage device; detecting whether there is a valid software upgrade package file in the mobile storage device if the POS terminal is connected to the mobile storage device; displaying a software upgrade management interface including a name of the valid software upgrade package file on the POS terminal if there is a valid software upgrade package file in the mobile storage device; obtaining a software upgrade package file selected through the software upgrade management interface; performing an upgrade according to the selected software upgrade package file; and restarting the POS terminal if the upgrade is successful.

### CROSS-REFERENCES TO RELATED APPLICATION

This application claims priority to Chinese Patent Application No. 201710125147.7, filed with the Chinese Patent Office on Mar. 3, 2017 and entitled “METHOD FOR UPGRADING POS TERMINAL SOFTWARE AND POS TERMINAL”, which is incorporated herein by reference in its entirety.

### TECHNICAL FIELD

The present application relates to the field of computer technologies, and in particular, to a method for upgrading POS terminal software, a POS terminal and a storage medium.

### BACKGROUND

In the traditional method for upgrading POS terminal software, the server is connected through the Internet or a modem, and then the POS terminal upgrade software is downloaded from the server and is installed, which realizes the online upgrade of the POS terminal software, or the computer is connected through the serial interface or the USB interface, and then the POS terminal upgrade software is downloaded from the computer and is installed, which realizes the local upgrade of the POS terminal software.

However, this method of online POS terminal software upgrade relies on a network or a computer, which brings inconvenience to the maintenance of the POS terminal software.

### SUMMARY

According to embodiments of the present application, a method for upgrading POS terminal software, a POS terminal and a storage medium are provided.

A method for upgrading POS terminal software, including:
starting a POS terminal;
detecting whether the POS terminal is connected to a mobile storage device;
detecting whether there is a valid software upgrade package file in the mobile storage device if the POS terminal is connected to the mobile storage device;
displaying a software upgrade management interface including a name of the valid software upgrade package file on the POS terminal if there is a valid software upgrade package file in the mobile storage device;
obtaining a software upgrade package file selected through the software upgrade management interface;

performing an upgrade according to the selected software upgrade package file; and
restarting the POS terminal if the upgrade is successful.

A POS terminal including a memory and a processor, the memory storing computer readable instructions, where the processor is configured to perform following steps when executing the computer readable instructions:
starting a POS terminal;
detecting whether the POS terminal is connected to a mobile storage device;
detecting whether there is a valid software upgrade package file in the mobile storage device if the POS terminal is connected to the mobile storage device;
displaying a software upgrade management interface including a name of the valid software upgrade package file on the POS terminal if there is a valid software upgrade package file in the mobile storage device;
obtaining a software upgrade package file selected through the software upgrade management interface;
performing an upgrade according to the selected software upgrade package file; and
restarting the POS terminal if the upgrade is successful.

One or more computer readable non-volatile storage media with computer readable instructions stored therein, where the computer readable instructions are configured to cause one or more processors to perform following steps when executed by the one or more processors:
starting a POS terminal;
detecting whether the POS terminal is connected to a mobile storage device;
detecting whether there is a valid software upgrade package file in the mobile storage device if the POS terminal is connected to the mobile storage device;
displaying a software upgrade management interface including a name of the valid software upgrade package file on the POS terminal if there is a valid software upgrade package file in the mobile storage device;
obtaining a software upgrade package file selected through the software upgrade management interface;
performing an upgrade according to the selected software upgrade package file; and restarting the POS terminal if the upgrade is successful.

Details of one or more embodiments of the present application are set forth in the accompanying drawings and description below. Other features, objects, and advantages of the invention will be apparent from the description and appended claims.

### BRIEF DESCRIPTION OF THE DRAWINGS

In order to more clearly illustrate the technical solutions in the embodiments of the present application, the drawings to be used in the embodiments will be briefly described below. Obviously, the drawings in the following description are only some embodiments of the present application. Those skilled in the art can also obtain other drawings based on these drawings without any creative work.

FIG. 1 is a diagram of internal structure of a POS terminal in an embodiment;

FIG. 2 is a flowchart of a method for upgrading POS terminal software in an embodiment;

FIG. 3 is a method for detecting an effective software upgrade package file in FIG. 2 in an embodiment;

FIG. 4 is a security verification method of the software upgrade package file in FIG. 2 in an embodiment;

FIG. 5 is a schematic diagram of the method for performing the upgrade according to the software upgrade package file in FIG. 2 in an embodiment;

FIG. 6 is a flowchart of a method for upgrading POS terminal software in another embodiment; and

FIG. 7 is a block diagram of structure of a POS terminal in an embodiment.

### DESCRIPTION OF THE EMBODIMENTS

In order to make the objects, technical solutions, and advantages of the present application more comprehensible, the present application will be further described in detail below with reference to the accompanying drawings and embodiments. It should be understood that the specific embodiments described herein are merely illustrative of the application and are not intended to limit the present application.

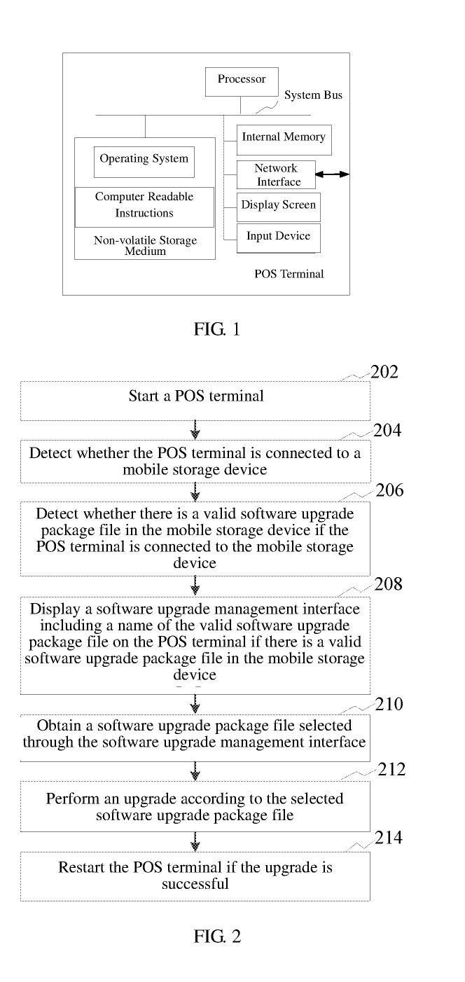

FIG. 1 is a schematic diagram of structure of a POS terminal in an embodiment. As shown in FIG. 1, the POS terminal includes a processor, a non-volatile storage medium, an internal memory, a data transmission interface, a display screen and an input device which are connected through a system bus. Where, the non-volatile storage medium of the POS terminal stores an operating system and computer readable instructions, the computer readable instructions are executed by the processor to implement a firmware upgrade method. The processor is used to provide computing and control capabilities to support the operation of the entire POS terminal. The data transmission interface is used for communication with other mobile storage devices, such as connecting to a USB flash drive through a USB (Universal Serial Bus) interface, downloading a software upgrade package file, and the like. The display screen of the terminal may be a liquid crystal display or an electronic ink display screen, and the input device may be a touch layer covered on the display screen or may be a button provided on the terminal housing. A person skilled in the art can understand that the structure shown in FIG. 1 is only a block diagram of parts of the structure related to the solution of the present application and does not constitute a limitation on the terminal to which the solution of the present application is applied. Specifically, the terminal may include more or fewer components than those are shown in the figure, or may combine some components, or have different component arrangements.

As shown in FIG. 2, in an embodiment, a method for upgrading a POS terminal software is provided. The method is applied to the terminal shown in FIG. 1 as an example for description and includes steps 202, 204, 206, 208, 210, 212 and 214.

In step 202, a POS terminal is started.

In this embodiment, when the POS terminal software is upgraded, the POS terminal device needs to be in the power-on state.

In step 204, it is detected whether the POS terminal is connected to the mobile storage device.

Mobile storage devices refer to portable data storage devices such as USB flash drives, mobile hard drives, and the like.

In step 206, if the POS terminal is connected to the mobile storage device, it is detected whether there is a valid software upgrade package file in the mobile storage device.

In this embodiment, detecting whether there is a valid software upgrade package file in the mobile storage device is divided into two steps: detecting whether there is a software upgrade package file in the mobile storage device; and detecting whether the software upgrade package file is valid if there is a software upgrade package file in the mobile storage device.

Specifically, according to the file type of the pre-made software upgrade package, the file of this file type is traversed in the root directory of the mobile storage device; if the search result is not empty, the found file is parsed, and corresponding value of the valid identifier of the file is obtained; if the corresponding value of the valid identifier of the file is a preset valid value, it indicates that there is a valid software upgrade package file in the mobile storage device; otherwise, there is no valid software upgrade package file in the mobile storage device.

One or more valid software upgrade package files may be stored in a mobile storage device. Meanwhile, the system type corresponding to the software upgrade package is not limited. For example, the software upgrade package may be a software upgrade package under the Windows system, a software upgrade package under a Linux system, a software upgrade package under Android system or a software upgrade package under Paxme system.

In step 208, if there is a valid software upgrade package file in the mobile storage device, a software upgrade management interface including a name of the valid software upgrade package file is displayed on the POS terminal.

In this embodiment, after determining that there is a valid software upgrade package file in the mobile storage device, the name of the valid software upgrade package file name is obtained, and a software upgrade management interface including the name of the valid software upgrade package file is displayed in the POS terminal.

In an embodiment, the software upgrade management interface may also display the name of the application that exists in the current system of the POS terminal, so that the user can implement the deletion function of the application of the POS terminal through the software upgrade management interface. In an embodiment, the software upgrade management interface may also display the name of the upgrade data file in the software upgrade package, such as the name of the public file (font library, etc.), the name of the application, and the name of the operating system program, so that the user implements partial upgrade of the POS terminal, such as only upgrading the operating system, via the software upgrade management interface.

In step 210, a software upgrade package file selected through the software upgrade management interface is obtained.

In this embodiment, a plurality of valid software upgrade package files are stored in the mobile storage device, for example, different users form different effective software upgrade package files due to different requirements. Thus, the POS terminal does not know which software upgrade package file is used for software upgrade, the software upgrade package file selected by the user through the software upgrade management interface need be obtained.

In step 212, an upgrade is performed according to the selected software upgrade package file.

In this embodiment, the upgraded data corresponding to the POS terminal is obtained by parsing the selected software upgrade package file, and the upgrade data is installed into the POS terminal.

In step 214, if the upgrade is successful, the POS terminal is restarted.

In this embodiment, the upgrade data corresponding to the POS terminal is installed, and in the process of installing the upgrade data corresponding to the POS terminal into the POS terminal, if no abnormality occurs, the upgrade is successful. After the software upgrade is successful, the POS terminal is restarted to make the data in the software upgrade package file take effect.

In this embodiment, the POS terminal software upgrade method is implemented offline, and the network and the computer are not required to be used, thereby improving the convenience of maintenance of the POS terminal software.

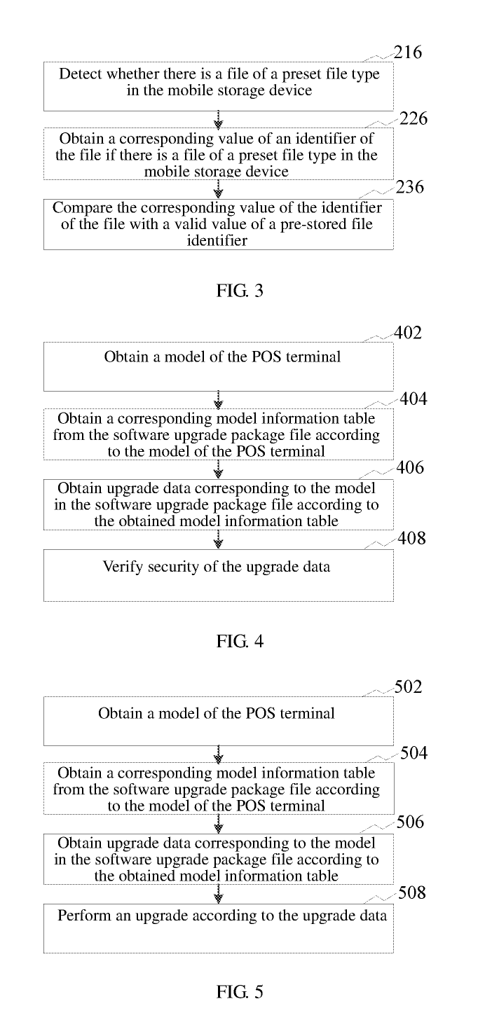

In one embodiment, as shown in FIG. 3, step 206 includes steps 216, 226 and 236.

In step 216, it is detected whether there is a file of a preset file type in the mobile storage device.

The preset file type is a compressed file type in which a plurality of files, such as an operating system program, an application program, and a font library, required for upgrading the POS terminal software are compressed into one file in advance using the upgrade package creation tool.

In this embodiment, the specific preset file type is pck.

In step 226, if there is a file of a preset file type in the mobile storage device, a corresponding value of the identifier of the file is obtained.

In this embodiment, the software upgrade package information table is obtained by parsing the file of the preset file type in the mobile storage device, and the software upgrade package information table includes the identifier of the file, the version information, the number of POS terminal models, the supported software system type, and the model information offset address of the POS terminal etc., the corresponding value of the identifier of the file is obtained, and the validity of the file is determined according to the corresponding value of the identifier of the file.

In step 236, the corresponding value of the identifier of the file is compared with the valid value of the pre-stored file identifier.

If the corresponding value of the obtained identifier of the file is consistent with the valid value of the pre-stored file identifier, the file of the preset file type in the mobile storage device is a valid file; otherwise, the file of the preset file type in the mobile storage device is an invalid file.

In an embodiment, after step 210, the method further includes: verifying security of the selected software upgrade package file; if the selected software upgrade package file is verified to be secure, entering the step of performing the upgrade according to the selected software upgrade package file. In this embodiment, by adding the step of verifying the security of the selected software upgrade package file, the security of the POS terminal software upgrade data is ensured.

In one embodiment, as shown in FIG. 4, the step of verifying the security of the selected software upgrade package file include steps 402, 404, 406 and 408. In step 402, a model of the POS terminal is obtained.

The software upgrade package file contains software upgrade data for different models. To ensure smooth upgrade of the POS terminal software, the software upgrade data corresponding to the current POS terminal model need to be obtained.

In step 404, a corresponding model information table is obtained from the software upgrade package file according to the model of the POS terminal.

In this embodiment, the model information table includes an upgrade data type of the model, an upgrade data storage address, and an upgrade data length information, wherein the upgrade data type of the model includes an operating system program, a public file (such as a font library), and an application program.

In step 406, upgrade data corresponding to the model in the software upgrade package file is obtained according to the obtained model information table.

According to the upgrade data type of the model and the corresponding upgrade data storage address in the model table, all the data files required for the POS terminal upgrade can be accurately found.

In step 408, the security of the upgrade data is verified.

In this embodiment, the digital signature technology is used to verify the security of all data files required for the POS terminal upgrade. Specifically, the last 256 bytes of digital signature information of each of the plurality of upgrade data files obtained in step 306 are separately parsed, and the RSA public key in the POS terminal is used to decrypt the signature information and the summary information of each of the upgrade date files is parsed, a hash algorithm is used to calculate the summary information of each data file, and finally, the summary information of each parsed upgrade data file is compared with the summary information of each upgrade file calculated by using the hash algorithm, if the comparison results are consistent, the verification result is safe.

In one embodiment, as shown in FIG. 5, step 212 includes steps 502, 504, 506 and 508.

In step 502, a model of the POS terminal is obtained.

Similarly, the software upgrade package file contains software upgrade data for multiple different models. To ensure smooth upgrade of the POS terminal software, the software upgrade data corresponding to the model of the current POS terminal need to be obtained.

In step 504, a corresponding model information table is obtained from the software upgrade package file according to the model of the POS terminal.

In this embodiment, the model information table includes an upgrade data type of the model, an upgrade data storage address, and an upgrade data length information, where the upgrade data type of the model includes an operating system program, a public file (such as a font library), and an application program.

In step 506, upgrade data corresponding to the model in the software upgrade package file is obtained according to the obtained model information table.

According to the upgrade data type of the model and the corresponding upgrade data storage address in the model table, all the data files required for the POS terminal upgrade can be accurately found.

In step 508, the upgrade is performed according to the software upgrade data.

In this embodiment, the upgrade data is installed into the POS terminal to implement software upgrade of the POS terminal.

In this embodiment, an upgrade package includes data files of multiple models, thus a software upgrade package may be shared for multiple models, upgrade file management is simplified, and the convenience of POS terminal software maintenance is improved.

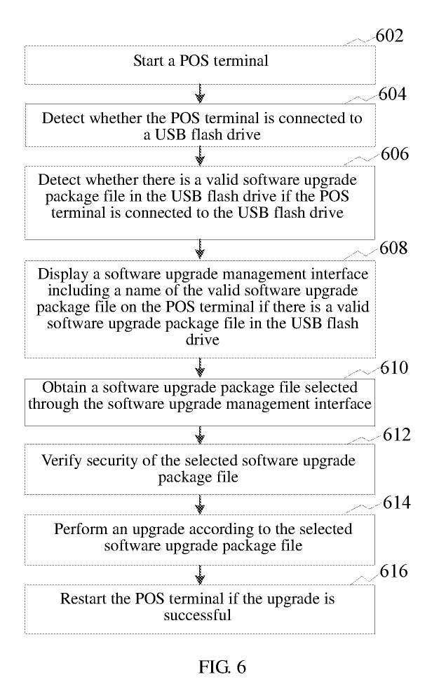

In one embodiment, after step 214, the method further includes: generating a software upgrade record; storing the software upgrade record in the mobile storage device; and printing the upgrade record in the mobile storage device. The software upgrade record includes: the model of the POS terminal, the name of the selected software upgrade package file, the name of the selected upgrade data file, the upgrade time and the upgrade status. In this embodiment, the upgrade record is printed by the POS terminal, and the software upgrade certificate is generated. In an embodiment, as shown in FIG. 6, another method for upgrading POS terminal software is provided, including steps 602, 604, 606, 608, 610, 612, 614 and 616.

In step 602, a POS terminal is started.

In this embodiment, when the POS terminal software is upgraded, the POS terminal device needs to be in the power-on state.

In step 604, it is detected whether the POS terminal is connected to a USB flash drive.

In this embodiment, whether the POS terminal is connected to the USB flash drive is detected by monitoring the USB port.

In step 606, it is detected whether there is a valid software upgrade package file in the USB flash drive if the POS terminal is connected to the USB flash drive.

In this embodiment, first, in the root directory of the USB flash drive, a file with the extension pck is searched, if a file with the extension pck is found, this file is parsed to obtain the value of the identifier of the file flag, and the value of the flag is compared with the pre-stored valid value “PAX-LOAD-PKG” of the file identifier, if the comparison result is consistent the found pck file is valid, otherwise the found pck file is invalid.

In step 608, a software upgrade management interface including a name of the valid software upgrade package file is displayed on the POS terminal if there is a valid software upgrade package file in the USB flash drive.

In this embodiment, after determining that there is a valid software upgrade package file in the mobile storage device, the name of the valid software upgrade package file is obtained, and the software upgrade management interface including the name of the valid software upgrade package file is displayed on the POS terminal.

In step 610, a software upgrade package file selected through the software upgrade management interface is obtained.

In this embodiment, a plurality of valid pck files are detected in the USB flash drive due to the upgrade requirements of different users. Thus, the POS terminal does not know which software upgrade package file is used for software upgrade, the software upgrade package file selected by the user through the software upgrade management interface need be obtained.

In step 612, security of the selected software upgrade package file is verified.

In this embodiment, the model of the POS terminal is first obtained, the corresponding model information table is obtained from the software upgrade package file according to the model of the POS terminal, and the upgrade data storage address corresponding to the model of the POS terminal is obtained, then the upgrade data file corresponding to the POS terminal is obtained according to the upgrade data storage address, and finally the security of the found upgrade data file is verified by using the digital signature technology. Where verifying the security of the found upgrade data file by using the digital signature technology includes: the last 256 bytes of digital signature information of each of the plurality of upgrade data files obtained in step 306 are separately parsed, and the RSA public key in the POS terminal is used to decrypt the signature information and the summary information of each of the upgrade date files is parsed, a hash algorithm is used to calculate the summary information of each data file, and finally, the summary information of each parsed upgrade data file is compared with the summary information of each upgrade file calculated by using the hash algorithm, if the comparison results are consistent, the verification result is safe.

In step 614, an upgrade is performed according to the selected software upgrade package file.

In this embodiment, the upgrade data file obtained in step 512 is installed to the POS terminal to implement software upgrade of the POS terminal. The upgrade data corresponding to the POS terminal is installed, and in the process of installing the upgrade data corresponding to the POS terminal into the POS terminal, if no abnormality occurs, the upgrade is successful.

In step 616, if the upgrade is successful, the POS terminal is restarted.

In this embodiment, after the upgrade is successfully completed, the POS terminal is restarted to make the installed upgrade data take effect.

In this embodiment, the POS terminal software upgrade is implemented offline, and the network and the computer are not required to be used, thereby improving the convenience of maintenance OF the POS terminal software. An upgrade package includes data files of multiple models, thus a software upgrade package may be shared for multiple models, upgrade file management is simplified, and the convenience of POS terminal software maintenance is improved. Furthermore, by adding the step of verifying the security of the selected software upgrade package file, the security of the POS terminal software upgrade data is ensured.

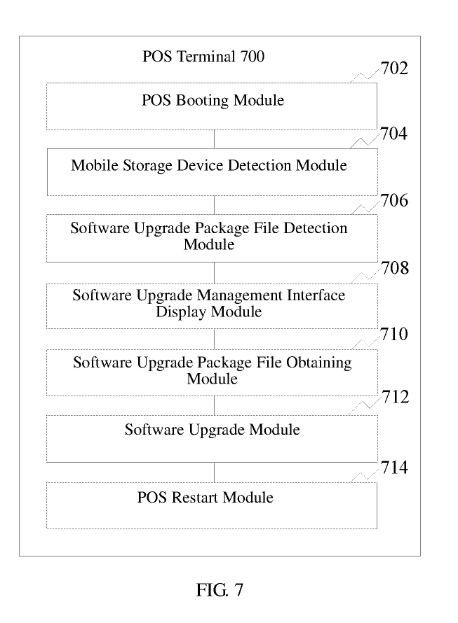

In one embodiment, as shown in FIG. 7, a block diagram of structural of a POS terminal 700 is provided. The internal structure of the terminal can be referred to the terminal shown in FIG. 1. Each of the modules described below can be implemented in whole or in part by software, hardware, or a combination thereof.

Referring to FIG. 7, the POS terminal 700 includes:
a POS booting module 702, configured to start a POS terminal;
a mobile storage device detection module 704, configured to detect whether the POS terminal is connected to the mobile storage device;
a software upgrade package file detection module 706, configured to detect whether there is a valid software upgrade package file in the mobile storage device if the POS terminal is connected to the mobile storage device;
a software upgrade management interface display module 708, configured to display a software upgrade management interface including a name of the valid software upgrade package file on the POS terminal if there is a valid software upgrade package file in the mobile storage device;
a software upgrade package file obtaining module 710, configured to obtain a software upgrade package file selected through the software upgrade management interface;
a software upgrade module 712, configured to perform an upgrade according to the selected software upgrade package file; and
a POS restart module 714, configured to restart the POS terminal if the upgrade is successful.

In one embodiment, the software upgrade package file detection module 706 is configured to detect whether there is a file of a preset file type in the mobile storage device, obtain a corresponding value of an identifier of the file if there is a file of a preset file type in the mobile storage device, and compare the corresponding value of the identifier of the file with a valid value of a pre-stored file identifier.

In an embodiment, the POS terminal further includes a security verification module, configured to verify security of the selected software upgrade package file; and the software upgrade module 712 is configured to enter the step of performing the upgrade according to the selected software upgrade package file if the selected software upgrade package file is verified to be secure.

In an embodiment, the security verification module is configured to obtain a model of the POS terminal, obtain a corresponding model information table from the software upgrade package file according to the model of the POS terminal, obtain the upgrade data corresponding to the model in the software upgrade package file according to the obtained model information table, and verify the security of the upgrade data.

In an embodiment, the software upgrade module 712 is configured to obtain a model of the POS terminal, obtain a corresponding model information table from the software upgrade package file according to the model of the POS terminal, obtain the upgrade data corresponding to the model in the software upgrade package file according to the obtained model information table, and perform the upgrade according to the upgrade data.

In an embodiment, the POS terminal further includes: an upgrade record generating module, configured to generate a software upgrade record and store the software upgrade record in the mobile storage device; and an upgrade record printing module, configured to print the upgrade record in the mobile storage device.

In one embodiment, one or more computer readable non-volatile storage media having computer readable instructions stored therein is provided, when being executed by one or more processors, the computer readable instructions cause the one or more processors to perform the following steps:
starting a POS terminal;
detecting whether the POS terminal is connected to a mobile storage device;
detecting whether there is a valid software upgrade package file in the mobile storage device if the POS terminal is connected to the mobile storage device;
displaying a software upgrade management interface including a name of the valid software upgrade package file on the POS terminal if there is a valid software upgrade package file in the mobile storage device;
obtaining a software upgrade package file selected through the software upgrade management interface;
performing an upgrade according to the selected software upgrade package file; and restarting the POS terminal if the upgrade is successful.

In an embodiment, the processor performs the step of detecting whether there is a valid software upgrade package file in the mobile storage device including: detecting whether there is a file of a preset file type in the mobile storage device, obtaining a corresponding value of the identifier of the file if there is a file of a preset file type in the mobile storage device, and comparing the corresponding value of the identifier of the file with the valid value of the pre-stored file identifier.

In an embodiment, after the processor performs the step of obtaining the software upgrade package file selected through the software upgrade management interface, the processor further performs the following steps: verifying security of the selected software upgrade package file; and performing the upgrade according to the selected software upgrade package file if the selected software upgrade package file is verified to be secure.

In an embodiment, the processor performs the step of verify security of the selected software upgrade package file includes: obtaining a model of the POS terminal, obtaining a corresponding model information table from the software upgrade package file according to the model of the POS terminal, obtaining upgrade data corresponding to the model in the software upgrade package file according to the obtained model information table, and verifying security of the upgrade data.

In an embodiment, the processor performs the step of performing an upgrade according to the selected software upgrade package file including: obtaining a model of the POS terminal, obtaining a corresponding model information table from the software upgrade package file according to the model of the POS terminal, obtaining upgrade data corresponding to the model in the software upgrade package file according to the obtained model information table, and performing an upgrade according to the upgrade data.

The technical features of the above-described embodiments may be arbitrarily combined. For the sake of brevity of description, not all possible combinations of the technical features in the above embodiments are described. However, as long as there is no contradiction in the combinations of these technical features, all the combinations should be considered as the scope of the specification.

The above-mentioned embodiments are merely illustrative of several embodiments of the present application, and the description thereof is more specific and detailed, but should not be construed as limiting the scope of the application. It should be noted that a number of variations and modifications may be made by those skilled in the art without departing from the spirit and scope of the present application. Therefore, the scope of the application should be determined by the appended claims.

1-15. (canceled)

16. A method for upgrading POS terminal software, comprising:
starting a POS terminal;
detecting whether the POS terminal is connected to a mobile storage device;
detecting whether there is a valid software upgrade package file in the mobile storage device if the POS terminal is connected to the mobile storage device;
displaying a software upgrade management interface including a name of the valid software upgrade package file on the POS terminal if there is a valid software upgrade package file in the mobile storage device;
obtaining a software upgrade package file selected through the software upgrade management interface;
performing an upgrade according to the selected software upgrade package file; and
restarting the POS terminal if the upgrade is successful.

17. The method according to claim 16, wherein said detecting whether there is a valid software upgrade package file in the mobile storage device comprises:
detecting whether there is a file of a preset file type in the mobile storage device;
obtaining a corresponding value of an identifier of the file if there is a file of a preset file type in the mobile storage device; and
comparing the corresponding value of the identifier of the file with a valid value of a pre-stored file identifier.

18. The method according to claim 16, wherein after said obtaining a software upgrade package file selected through the software upgrade management interface, the method further comprises:
verifying security of the selected software upgrade package file; and
performing an upgrade according to the selected software upgrade package file if the selected software upgrade package file is verified to be secure.

19. The method according to claim 18, wherein said verifying security of the selected software upgrade package file comprises:
obtaining a model of the POS terminal;
obtaining a corresponding model information table from the software upgrade package file according to the model of the POS terminal;
obtaining upgrade data corresponding to the model in the software upgrade package file according to the obtained model information table; and
verifying security of the upgrade data.

20. The method according to claim 16, wherein said performing an upgrade according to the selected software upgrade package file comprises:
obtaining a model of the POS terminal;
obtaining a corresponding model information table from the software upgrade package file according to the model of the POS terminal;
obtaining upgrade data corresponding to the model in the software upgrade package file according to the obtained model information table; and
performing an upgrade according to the upgrade data.

21. A POS terminal comprising a memory and a processor, the memory storing computer readable instructions, and the processor is configured to perform following steps when executing the computer readable instructions:
starting a POS terminal;
detecting whether the POS terminal is connected to a mobile storage device;
detecting whether there is a valid software upgrade package file in the mobile storage device if the POS terminal is connected to the mobile storage device;
displaying a software upgrade management interface including a name of the valid software upgrade package file on the POS terminal if there is a valid software upgrade package file in the mobile storage device;
obtaining a software upgrade package file selected through the software upgrade management interface;
performing an upgrade according to the selected software upgrade package file; and
restarting the POS terminal if the upgrade is successful.

22. The POS terminal according to claim 21, wherein the processor performing said detecting whether there is a valid software upgrade package file in the mobile storage device comprises:
detecting whether there is a file of a preset file type in the mobile storage device;
obtaining a corresponding value of an identifier of the file if there is a file of a preset file type in the mobile storage device; and
comparing the corresponding value of the identifier of the file with a valid value of a pre-stored file identifier.

23. The POS terminal according to claim 21, wherein after the processor performs said obtaining a software upgrade package file selected through the software upgrade management interface, the processor further performs following steps:
verifying security of the selected software upgrade package file; and
performing an upgrade according to the selected software upgrade package file if the selected software upgrade package file is verified to be secure.

24. The POS terminal according to claim 23, wherein the processor performing said verifying security of the selected software upgrade package file comprises:
obtaining a model of the POS terminal;
obtaining a corresponding model information table from the software upgrade package file according to the model of the POS terminal;
obtaining upgrade data corresponding to the model in the software upgrade package file according to the obtained model information table; and
verifying security of the upgrade data.

25. The POS terminal according to claim 21, wherein the processor performing said performing an upgrade according to the selected software upgrade package file comprises:
obtaining a model of the POS terminal;
obtaining a corresponding model information table from the software upgrade package file according to the model of the POS terminal;
obtaining upgrade data corresponding to the model in the software upgrade package file according to the obtained model information table; and
performing an upgrade according to the upgrade data.

26. One or more computer readable non-volatile storage media with computer readable instructions stored therein, and the computer readable instructions are configured to cause one or more processors to perform following steps when executed by the one or more processors:
starting a POS terminal;
detecting whether the POS terminal is connected to a mobile storage device;
detecting whether there is a valid software upgrade package file in the mobile storage device if the POS terminal is connected to the mobile storage device;
displaying a software upgrade management interface including a name of the valid software upgrade package file on the POS terminal if there is a valid software upgrade package file in the mobile storage device;
obtaining a software upgrade package file selected through the software upgrade management interface;
performing an upgrade according to the selected software upgrade package file; and
restarting the POS terminal if the upgrade is successful.

27. The storage medium according to claim 26, wherein the processor performing said detecting whether there is a valid software upgrade package file in the mobile storage device comprises:
detecting whether there is a file of a preset file type in the mobile storage device;
obtaining a corresponding value of an identifier of the file if there is a file of a preset file type in the mobile storage device; and
comparing the corresponding value of the identifier of the file with a valid value of a pre-stored file identifier.

28. The storage medium according to claim 26, wherein after the processor performs said obtaining a software upgrade package file selected through the software upgrade management interface, the processor further performs following steps:
verifying security of the selected software upgrade package file; and
performing an upgrade according to the selected software upgrade package file if the selected software upgrade package file is verified to be secure.

29. The storage medium according to claim 28, wherein the processor performing said verifying security of the selected software upgrade package file comprises:
obtaining a model of the POS terminal;
obtaining a corresponding model information table from the software upgrade package file according to the model of the POS terminal;
obtaining upgrade data corresponding to the model in the software upgrade package file according to the obtained model information table; and
verifying security of the upgrade data.

30. The storage medium according to claim 26, wherein the processor performing said performing an upgrade according to the selected software upgrade package file comprises:
obtaining a model of the POS terminal;
obtaining a corresponding model information table from the software upgrade package file according to the model of the POS terminal;
obtaining upgrade data corresponding to the model in the software upgrade package file according to the obtained model information table; and
performing an upgrade according to the upgrade data.
